(19) United States
(12) Patent Application Publication
(10) Pub. No.: US 2025/0250205 A1
(43) Pub. Date: Aug. 7, 2025

(54) UTILIZATION OF SULFUR POWDER IN CEMENTITIOUS MATERIALS

(71) Applicant: Saudi Arabian Oil Company, Dhahran (SA)

(72) Inventors: Mohammed Al-Mehthel, Dhahran (SA); Hassan Al-Khalifah, Sayhat (SA); Mohammed Semilan, Dhahran (SA)

(73) Assignee: Saudi Arabian Oil Company, Dhahran (SA)

(21) Appl. No.: 18/431,015

(22) Filed: Feb. 2, 2024

(51) Int. Cl. C04B 22/02; C04B 28/04; C04B 28/36

(52) U.S. Cl. CPC C04B 22/02; C04B 28/04; C04B 28/36; C04B 2201/20; C04B 2201/52

(57) ABSTRACT

A cement composition utilizing powdered elemental sulfur may comprise a cementitious material; the powdered elemental sulfur, wherein the powdered elemental sulfur has an average particle size of less than or equal to 45 microns; at least one of a coarse aggregate or a fine aggregate; and an aqueous solution. A method of making a cement composition utilizing powdered elemental sulfur may comprise: mixing a cementitious material with the powdered elemental sulfur at less than 127° C. to form a dry mixture, the powdered elemental sulfur having an average particle size of less than or equal to 45 microns; combining the dry mixture with an aqueous solution at a temperature of less than 127° C. to form a wet mixture; and mixing at least one of a course aggregate or a fine aggregate with the dry mixture or the wet mixture at a temperature of less than 127° C.

### TECHNICAL FIELD

Embodiments herein generally relate to cement compositions, and more specifically, to cement compositions comprising powdered elemental sulfur, as well as to methods of making and using the same.

### BACKGROUND

Typical cement concrete is a mixture of Portland cement, sand, aggregates, and water. Such Portland cement concrete can be used for a variety of purposes including the construction of buildings, sealing and isolation of natural resource wells, etc. In such cement concretes, the Portland cement is a binder that binds the concrete together. Unfortunately, the production of Portland cement is energy intensive because production consumes significant energy and, thus, produces considerable carbon dioxide (CO2). Indeed, the production of Portland cement includes heating cement clinker to 1400° C. to 1500° C., such as in a rotating kiln. In addition to the environmental issues, the heat required to produce cement clinker is a health and safety risk. Accordingly, among increasing concerns about climate change, compositions of cement and methods of producing the same that generate less carbon dioxide are continually desired.

### SUMMARY

Liquid sulfur, which is abundantly produced by oil refineries, can be used as an alternative binder for cementitious material in cements used for mortar or concrete. Sulfur can be produced as a by-product of oil and gas production, which can sometimes be in the form of elemental sulfur molecules containing only sulfur atoms (as opposed to, for example, a sulfate, such as SO₄). The elemental sulfur can melt at temperatures in the range of about 127° C. to about 149° C., and so some applications of using the same involve melting/liquefying the sulfur before being used as a binder for the cement composition, such as for mortar or concrete.

However, during the previous process, redox reactions of at least a portion of the sulfur may also occur, resulting in the formation of toxic emissions such as hydrogen sulfide or sulfur dioxide and potentially posing similar health and safety risks as in the formation of traditional Portland cement. Further, without the addition of certain co-additives or fillers during the formation process, the resulting sulfur and cement composition may be susceptible to deterioration when exposed to water.

Accordingly, cement compositions and methods of forming the same are desired which can utilize non-liquid/non-molten elemental sulfur, such as in a powdered or granule form. Accordingly, provided herein are cement compositions utilizing elemental sulfur in powder/granule form, as well as methods of making and using the same that occur at temperatures less than 127° C., such that the elemental sulfur does not melt, reduce, or oxidize to a substantial degree. Accordingly, the resulting cement composition may not be susceptible to water degradation, increasing the range of use. Furthermore, since the sulfur is not susceptible to water degradation, the elemental sulfur may act as a partial replacement of the cementitious material, allowing additional amounts of elemental sulfur to be used in the mix.

As an additional benefit, the powdered elemental sulfur may also be of a fine particle size, such as less than 45 microns, such as from 20 to 10 microns, such that the powdered elemental sulfur may contribute to increased packing of the cement matrix, resulting in increased compressive strength and density of the resulting cement composition. Moreover, the particle size of the powdered elemental sulfur may be equal to or less than an average grain size of the cementitious material, such that the amount of powdered elemental sulfur that can be added without negatively impacting compressive strength may be increased with respect to coarser grained elemental sulfur, as the fine grained elemental sulfur will distribute and fill the voids in the cement matrix, rather than supporting the integrity of the matrix if at the coarser grained size.

Finally, as formation of cement with traditional clinkers and/or cementitious materials often results in the release of greenhouse gases, mortars/concretes formed according to the previous will lower the carbon footprint of the cement composition due to the reduction of the cementitious material content.

In accordance with one embodiment herein, a cement composition utilizing powdered elemental sulfur comprises a cementitious material; powdered elemental sulfur, wherein the powdered elemental sulfur has an average particle size of less than or equal to 45 microns; at least one of a coarse aggregate or a fine aggregate; and an aqueous solution.

In accordance with another embodiment herein, a method of making a cement composition utilizing powdered elemental sulfur comprises mixing a cementitious material with the powdered elemental sulfur at a temperature of less than 127° C. to form a dry mixture, the powdered elemental sulfur having an average particle size of less than or equal to 45 microns; combining the dry mixture with an aqueous solution at a temperature of less than 127° C. to form a wet mixture; and mixing at least one of a course aggregate or a fine aggregate with the dry mixture or the wet mixture at a temperature of less than 127° C.

In accordance with yet another embodiment herein, a method of using a cement composition utilizing powdered elemental sulfur comprises mixing a cementitious material with the powdered elemental sulfur at a temperature of less than 127° C. to form a dry mixture, the elemental sulfur having an average particle size of less than or equal to 45 microns; combining the dry mixture with an aqueous solution at a temperature of less than 127° C. to form a wet mixture; and mixing at least one of a course aggregate or a fine aggregate with the dry mixture or the wet mixture at a temperature of less than 127° C.; and curing the wet mixture to form the cement composition.

Additional features and advantages of the described embodiments will be set forth in the detailed description, which follows, and in part will be readily apparent to those skilled in the art from that description or recognized by practicing the described embodiments, including the detailed description, which follows, as well as the claims.

### DETAILED DESCRIPTION

As previously stated, embodiments herein generally relate to cement compositions, and more specifically, to cement compositions comprising powdered elemental sulfur, as well as to methods of making and using the same. In embodiments, the cement composition may comprise a cementitious material, powdered elemental sulfur, and an aqueous solution. In at least some embodiments, the cement composition may comprise at least one of a coarse aggregate or a fine aggregate. In some embodiments, the cement composition may further comprise admixtures.

As previously stated, the cement composition may comprise a cementitious material. The cementitious material may comprise Portland cement, such as Portland cement in accordance with ASTM C150, or cementitious materials in accordance with ASTM C595, or ASTM C1709, fly ash, silica fume, blast furnace slag, volcanic ash, or combinations thereof.

As previously stated, the cement composition may comprise powdered elemental sulfur. As used herein, “elemental sulfur” refers to not only singular sulfur atoms but also sulfur in complexes and sulfur covalently bonded to other sulfur atoms, including but not limited to α-sulfur (orthorhombic sulfur), β-sulfur (monoclinic sulfur), and “catena” sulfur. Chains or rings of sulfur atoms range from a few sulfur atoms to hundreds of covalently linked sulfur atoms. Because of the wide variety of allotropes, elemental sulfur is found in many different forms based upon modifications to its environment. Accordingly, sulfur that is covalently bonded with non-sulfur atoms, such as carbon, hydrogen, or other atomic species, including hetero-organic compounds, is not elemental sulfur. In some embodiments, the elemental sulfur may comprise from 90 wt. % to 99 wt. % sulfur and from 1 wt. % to 10 wt. % carbon and other impurities. The elemental sulfur may also be present in a weight ratio with the cementitious material of from 0.1% to 10% elemental sulfur to cementitious material.

As used herein, “fine grained elemental sulfur” refers to powdered/granule elemental sulfur having an average particle size of less than or equal to 45 microns (325 mesh), such as from 45 microns to 30 microns, from 30 microns to 20 microns, from 20 microns to 10 microns, or combinations of the previous or smaller ranges therein, such as from 20 microns to 10 microns. However, “fine grained elemental sulfur” may equally refer to powdered/granule elemental sulfur wherein at least 80 percent of the elemental sulfur has a particle size of less than or equal to 45 microns, such as from 45 microns to 30 microns, from 30 microns to 20 microns, from 20 microns to 10 microns, or combinations of the previous or smaller ranges therein. Similarly, “coarse grained elemental sulfur” refers to powdered/granule elemental sulfur having an average particle size of greater than 45 microns.

Further, without being limited by theory, at least one benefit of using fine grained elemental sulfur may be the increased density, packing, and compressive strength of the cement composition that may result from using the same (such as mortar or concrete), as compared to when coarse elemental sulfur is used. Moreover, in embodiments, additional fine grained elemental sulfur may be added to the cement composition without negatively impacting compressive strength as compared to if the coarse grained elemental sulfur was added. Without being limited by theory, this may be due at least to the ability of the finer grain to fill the pore/voids in the mortar/concrete matrix due to their higher surface area compared to the coarse grain. This will result in more packed matrix. Coarser grained elemental sulfur can act as aggregates, however coarse grained elemental sulfur is softer than other aggregates and will lower the compressive strength. In contrast, when fine elemental sulfur is used, such as elemental sulfur having an average particle size less than or equal to the average cementitious material grain (less than or equal to 45 microns), it fills the pore/voids in the cement composition/concrete/mortar matrix as the elemental sulfur can be adequately distributed within the coarse aggregate, fine aggregate and the cementitious material grains.

As previously stated, at least one benefit of using fine grained elemental sulfur may be the increased density, packing and compressive strength of the cement composition that may result from using the same, as compared to coarse elemental sulfur. Accordingly, the cement composition may not comprise a foaming agent, as the inclusion of such a density reducing agent, and the air void space resulting from the same, would run counter to the aforementioned benefits of including the fine elemental sulfur.

Accordingly, in embodiments not including the foaming agent, the cement composition may comprise an aqueous solution to cementitious material weight ratio of less than 4:10 aqueous solution to cementitious material. Whereas in embodiments including the foaming agent, the cement composition may comprise an aqueous solution to cementitious material weight ratio of greater than 4:10 aqueous solution to cementitious material. As previously stated, the greater ratio when including the foaming agent may thereby result in a lesser density for the resulting cement composition, thereby also reducing the compressive strength of the same. In embodiments, the cement composition may comprise a compressive strength of from 100 psi to 8,000 psi, and/or may have comprise a density of at least 1800 kg/m³, such as from 1800 kg/m³ to 2000 kg/m³, from 2000 kg/m³ to 2300 kg/m³, from 2300 kg/m³ to 2700 kg/m³, from 2700 kg/m³ to 3000 kg/m³, or any combination of the ranges or smaller range therein.

As previously stated, the cement composition may also comprise an aqueous solution. The aqueous solution may comprise water selected from the group consisting of the formation water, filtered seawater, untreated seawater, natural salt water; brackish salt water; saturated salt water; synthetic brine; mineral waters; potable water containing one or more dissolved salts, minerals, and organic materials; non-potable water containing one or more dissolved salts, minerals, and organic materials; deionized water; tap water; distilled water; fresh water; or combinations thereof. In one or more embodiments, the aqueous solution 212 may comprise at least 80 wt. %, at least 90 wt. %, at least 95 wt. %, at least 99 wt. %, or even at least 99.9 wt. % water.

In some embodiments, the cement composition may comprise at least one of a coarse aggregate or a fine aggregate. The coarse aggregate may comprise gravel, steel slag, or both. The fine aggregate may comprise sand, such as rolled sand or dune sand. Dune sand is a type of wind-carried sand that has been piled up by the wind into a sand dune, and may thus have rounded mineral grains. In some embodiments, the fine aggregate may comprise quartz sand. In embodiments, the coarse and fine aggregate may have a particle size as defined in ASTM C33 and/or ASTM C330.

In some embodiments, the cement composition may comprise a filler, such as, but not limited to, limestone powder, pozzolanic material, oil ash, baghouse particulates, black carbon, or combinations thereof. Additionally or alternatively, the cement composition may comprise at least one additional additive, such as, but not limited to, silica fume, blast furnace slag, recycled plastics, fibers, or rubber. The recycled plastics may comprise low density polyethylene (LDPE), linear low-density polyethylene (LLDPE), high-density polyethylene (HDPE), polycarbonate derived from electronic waste, or combinations thereof. The fibers may comprise polypropylene, polyethylene, or both.

As previously stated, the cement composition may comprise cementitious material, powdered elemental sulfur, a coarse aggregate, a fine aggregate, and an aqueous solution. In embodiments, the cement composition may comprise from 50 kg/m³ to 500 kg/m³ cementitious material; from 1 kg/m³ to 50 kg/m³ powdered elemental sulfur as partial replacement of the cementitious materials; from 1 kg/m³ to 1800 kg/m³ powdered elemental sulfur as filler; from 5 kg/m³ to 500 kg/m³ aqueous solution; from 1 kg/m³ to 1800 kg/m³ coarse aggregate; and from 1 kg/m³ to 2000 kg/m³ fine aggregate.

Additionally or alternatively, the cement composition may comprise from 10 wt. % to 50 wt. % cementitious material; from 0.1 wt. % to 10 wt. % powdered elemental sulfur as partial replacement of the cementitious materials; from 0.1 wt. % to 70 wt. % powdered elemental sulfur as filler; from 5 wt. % to 30 wt. % aqueous solution; from 0 wt. % to 0.7 wt. % coarse aggregate; and from 0.1 wt. % to 95 wt. % fine aggregate.

As previously stated, embodiments herein also relate to methods of making cement compositions. The cement compositions formed in the method of making and utilized in the methods of using may be any of the cement compositions previously described. The method of making the cement composition may initially comprise mixing the cementitious material with the powdered elemental sulfur to form a dry mixture. The method of making may also comprise combining the dry mixture with the aqueous solution to form a wet mixture. The method of making may also comprising mixing at least one of a coarse aggregate or a fine aggregate with the dry mixture or the wet mixture. The method of making may also comprise mixing at least one of silica fume, blast furnace slag, recycled plastics, fibers, rubber, or a filler with the dry mixture or the wet mixture.

In at least some embodiments, the various steps of the method of making may occur at less than 127° C., i.e. less than the melting point of the powdered elemental sulfur, such as from 127° C. to 100° C., from 100° C. to 75° C., from 75° C. to 50° C., from 50° C. to 25° C., from 25° C. to 18° C., from 18° C. to 0° C., or any combination of ranges or smaller range therein, such as from 0° C. to less than 127° C. Without being limited by theory, forming the cement composition at such a temperature range may prevent the melting of the powdered elemental sulfur during the method of making, thereby also preventing the release of hydrogen sulfide and sulfur dioxide in the process.

As previously stated, embodiments herein also relate to methods of using cement compositions. The method of using the cement composition may comprise the method of making the cement composition, and may additionally comprise curing the wet mixture to form the cement composition.

Having described the subject matter of the present embodiments herein in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present embodiments including, but not limited to, embodiments defined in the appended claims. More specifically, although some aspects of the present embodiments are identified herein as preferred or particularly advantageous, it is contemplated that the present embodiments is not necessarily limited to these aspects.

It is also noted that recitations herein of “at least one” component, element, etc., should not be used to create an inference that the alternative use of the articles “a” or “an” should be limited to a single component, element, etc.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.” It is noted that the use of the term “having” in this disclosure should also be interpreted in like manner as the more commonly used open-ended preamble term “comprising”.

What is claimed is:

1. A cement composition utilizing powdered elemental sulfur, the cement composition comprising:
a cementitious material;
the powdered elemental sulfur, wherein the powdered elemental sulfur has an average particle size of less than or equal to 45 microns;
at least one of a coarse aggregate or a fine aggregate; and
an aqueous solution.

2. The cement composition of claim 1, wherein at least 80 percent of the powdered elemental sulfur has a particle size of less than or equal to 45 microns.

3. The cement composition of claim 2, wherein at least 80 percent of the powdered elemental sulfur has a particle size of from 20 microns to 10 microns.

4. The cement composition of claim 1, wherein:
the cement composition does not comprise a foaming agent; and
the cement composition comprises an aqueous solution to cementitious material weight ratio of less than 4:10.

5. The cement composition of claim 1, wherein a weight ratio of the powdered elemental sulfur to cementitious material is from 0.1 to 10%.

6. The cement composition of claim 1, wherein the coarse aggregate and fine aggregate gradation meets ASTM C33.

7. The cement composition of claim 6, wherein the cement composition comprises:
from 50 kg/m³ to 500 kg/m³ cementitious material;
from 1 kg/m³ to 50 kg/m³ powdered elemental sulfur as partial replacement of cementitious material;
from 1 kg/m³ to 1800 kg/m³ powdered elemental sulfur as filler;
from 5 kg/m³ to 500 kg/m³ aqueous solution;
from 1 kg/m³ to 1800 kg/m³ coarse aggregate; and
from 1 kg/m³ to 2000 kg/m³ fine aggregate.

8. The cement composition of claim 6, wherein the cement composition comprises:
from 10 wt. % to 50 wt. % cementitious material;
from 0.1 wt. % to 10 wt. % powdered elemental sulfur as partial replacement of cementitious material;
from 0.1 wt. % to 70 wt. % powdered elemental sulfur as filler;
from 5 wt. % to 30 wt. % aqueous solution;
from 0 wt. % to 0.7 wt. % coarse aggregate; and
from 0.1 wt. % to 95 wt. % fine aggregate.

9. The cement composition of claim 1, wherein the cementitious material further comprises at least one of silica fume, blast furnace slag, recycled plastics, fibers, or rubber.

10. The cement composition of claim 9, wherein:
the recycled plastics comprise low density polyethylene (LDPE), linear low-density polyethylene (LLDPE), high-density polyethylene (HDPE), polycarbonate derived from electronic waste, or combinations thereof; and
the fibers comprise polypropylene, polyethylene, or both.

11. The cement composition of claim 1, wherein the cement composition further comprises a filler comprising limestone powder, pozzolanic material, oil ash, baghouse particulates, black carbon, or combinations thereof.

12. The cement composition of claim 1, wherein the powdered elemental sulfur comprises from 90 to 99 wt. % elemental sulfur and from 1 to 10 wt. % carbon.

13. The cement composition of claim 1, wherein the cement composition has a compressive strength of from 100 psi to 8,000 psi.

14. The cement composition of claim 1, where the cement composition has a density of at least 1800 kg/m³.

15. A method of making a cement composition utilizing powdered elemental sulfur, the method comprising:
mixing a cementitious material with the powdered elemental sulfur at a temperature of less than 127° C. to form a dry mixture, the powdered elemental sulfur having an average particle size of less than or equal to 45 microns;
combining the dry mixture with an aqueous solution at a temperature of less than 127° C. to form a wet mixture; and
mixing at least one of a course aggregate or a fine aggregate with the dry mixture or the wet mixture at a temperature of less than 127° C.

16. The method of claim 15, further comprising mixing at least one of silica fume, blast furnace slag, recycled plastics, fibers, rubber, or a filler with the dry mixture or the wet mixture.

17. The method of claim 15, wherein at least 80 percent of the powdered elemental sulfur has a particle size of less than or equal to 45 microns.

18. A method of using a cement composition utilizing powdered elemental sulfur, the method comprising:
mixing a cementitious material with the powdered elemental sulfur at a temperature of less than 127° C. to form a dry mixture, the elemental sulfur having an average particle size of less than or equal to 45 microns;
combining the dry mixture with an aqueous solution at a temperature of less than 127° C. to form a wet mixture;
mixing at least one of a course aggregate or a fine aggregate with the dry mixture or the wet mixture at a temperature of less than 127° C.; and
curing the wet mixture to form the cement composition.

19. The method of claim 18, further comprising mixing at least one of silica fume, blast furnace slag, recycled plastics, fibers, rubber, or a filler with the dry mixture or the wet mixture.

20. The method of claim 18, wherein at least 80 percent of the powdered elemental sulfur has a particle size of less than or equal to 45 microns.
